(19) United States
(12) Patent Application Publication
(10) Pub. No.: US 2007/0160264 A1
(43) Pub. Date: Jul. 12, 2007

(54) Biometric authentication apparatus, biometric authentication system and biometric data management method

(76) Inventors: Seitaro Kasahara, Tokyo (JP); Takashi Ueda, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/449,909

(22) Filed: Jun. 8, 2006

(30) Foreign Application Priority Data
Jan. 2, 2006 (JP) 2006-024507

(51) Int. Cl. G06K 9/00

(52) U.S. Cl. 382/115; 340/5.52

(57) ABSTRACT

Disclosed is an information processing device including a biometric authentication apparatus, including: an operation unit receiving an instruction from a user; a biometric reading unit reading biometric data; a verification data storage unit storing a plurality of pieces of verification data for verifying against the biometric data; a control unit verifying the biometric data read by the biometric reading unit against the verification data and storing the biometric data as the verification data into the verification data storage unit based on the instruction input through the operation unit; and an information unit informing of a verification result by the control unit, wherein the control unit verifies the biometric data against the verification data before the storage of the biometric data, and when the verification result indicates a disagreement, the control unit stores the biometric data into the verification data storage unit.

### CROSS-REFERENCE TO RELATED APPLICATION

The present U.S. patent application claims a priority under the Paris Convention of Japanese patent application No. 2006-24507 filed on Feb. 1, 2006, and shall be a basis of correction of an incorrect translation.

### BACKGROUND OF THE INVENTION

1. Field of the Invention

The present invention relates to a biometric authentication apparatus, a biometric authentication system, and a biometric data management method.

2. Description of Related Art

In recent years, authentication using biometric data of a person such as a fingerprint, a vein, an iris, a retina, a hand shape, a facial configuration, a somatotype, a voice print or the like for security protection has been widely recognized. Accordingly, techniques relative to the improvement of authentication accuracy and the improvement of an authentication speed have been proposed (for example, refer to JP-2003-186847A and JP-2001-344605A). Because authentication based on biometric data has no problems of loss unlike authentication by a possession such as an ID card or the like, the biometric data authentication has high convenience. Further, because the biometric data authentication has a feature of the difficulty of masquerade, the application of the biometric data authentication to various fields is being promoted. For example, an image formation apparatus such as a copier, a multi-function printer (MFP) or the like, having a biometric authentication function has been studied.

By the way, because registration and deletion of verification data described above is generally performed by an administrator of an authentication apparatus or an authentication system using an exclusive management tool, a user himself or herself cannot perform an additional registration of biometric data for verification (hereinafter it may be referred to as verification data) nor deletion of unnecessary verification data, and consequently such a system lacks convenience.

Furthermore, in the techniques disclosed in JP-2003-186847A and JP-2001-344605A, because management of verification data is performed by an administrator, the techniques cannot solve the problem mentioned above.

### SUMMARY

The present invention has been made to solve the above problems. An object of the invention is to provide a biometric authentication apparatus, a biometric authentication system or a biometric data management method, capable of increase in the level of convenience in the management of verification data.

In order to achieve the above object, according to one embodiment reflecting a first aspect of the present invention, the biometric authentication apparatus, comprises: an operation unit receiving an instruction from a user; a biometric reading unit reading biometric data; a verification data storage unit storing a plurality of pieces of verification data for verifying against the biometric data; a control unit verifying the biometric data read by the biometric reading unit against the verification data and storing the biometric data as the verification data into the verification data storage unit based on the instruction input through the operation unit; and an information unit informing of a verification result by the control unit, wherein the control unit verifies the biometric data against the verification data before the storage of the biometric data, and when the verification result indicates a disagreement, the control unit stores the biometric data into the verification data storage unit.

According to another embodiment reflecting a second aspect of the present invention, the biometric authentication apparatus, comprises: an operation unit receiving an instruction from a user; a biometric reading unit reading biometric data; a verification data storage unit storing a plurality of pieces of verification data for verifying against the biometric data; a control unit verifying the biometric data read by the biometric reading unit against the verification data and storing the biometric data as the verification data into the verification data storage unit based on the instruction input through the operation unit; and an information unit informing of a verification result by the control unit, wherein the information unit gives a notice of urging ascertainment of whether to store the biometric data into the verification data storage unit when a verification result by the control unit indicates a disagreement, and the control unit stores the biometric data into the verification data storage unit when an instruction allowing the storage of the biometric data into the verification data storage unit is input through the operation unit.

Preferably, the information unit informs of a result of the storage of the biometric data by the control unit.

Preferably, the biometric authentication apparatus further comprises a user management information storage unit storing user management information including identification information for identifying the user and/or personal identification number peculiar to the user, wherein the control unit stores the biometric data into the verification data storage unit when the user management information input through the operation unit agrees with the user management information stored in the user management information storage unit.

Preferably, when an instruction instructing deletion of specific verification data among the plurality of pieces of verification data stored in the verification data storage unit is input, the control unit deletes the specified verification data from the verification data storage unit.

Preferably, the biometric authentication apparatus further comprises a user management information storage unit storing user management information including identification information for identifying the user and/or personal identification number peculiar to the user, wherein when the user management information input through the operation unit agrees with the user management information stored in the user management information storage unit, the control unit deletes the specified verification data from the verification data storage unit.

The biometric reading unit preferably reads as the biometric data at least one of a fingerprint, a vein, an iris, a retina, a hand shape, a facial configuration, a somatotype and a voice print of the user.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a view showing the configuration of a biometric authentication system;

FIG. 2 is a view showing the internal configuration of an image formation apparatus 1 to which a biometric authentication apparatus of the present invention is applied;

FIG. 3 is a view showing an example of a priority order table stored in a storage unit;

FIG. 4 is a view showing the internal configuration of a biometric data server;

FIG. 5 is a view showing the procedure of verification data registration processing;

FIG. 6 is a view showing the procedure of duplication ascertainment processing in the verification data registration processing in FIG. 5;

FIG. 7 is a view showing the procedure of registration processing in the duplication ascertainment processing in FIG. 6;

FIG. 8 is a view showing the procedure of verification data deletion processing;

FIG. 9 is a view showing the procedure of biometric authentication processing;

FIG. 10 is a view showing the procedure of deletion processing in the biometric authentication processing in FIG. 9; and

FIG. 11 is a view showing the procedure of registration processing in the biometric authentication processing in FIG. 9.

### DETAILED DESCRIPTION OF THE PREFERRED EMBODIMENTS

An embodiment relating to the biometric authentication apparatus, the biometric authentication system, and the biometric data management method of the present invention will be described with reference to the attached drawings.

### <First Embodiment>

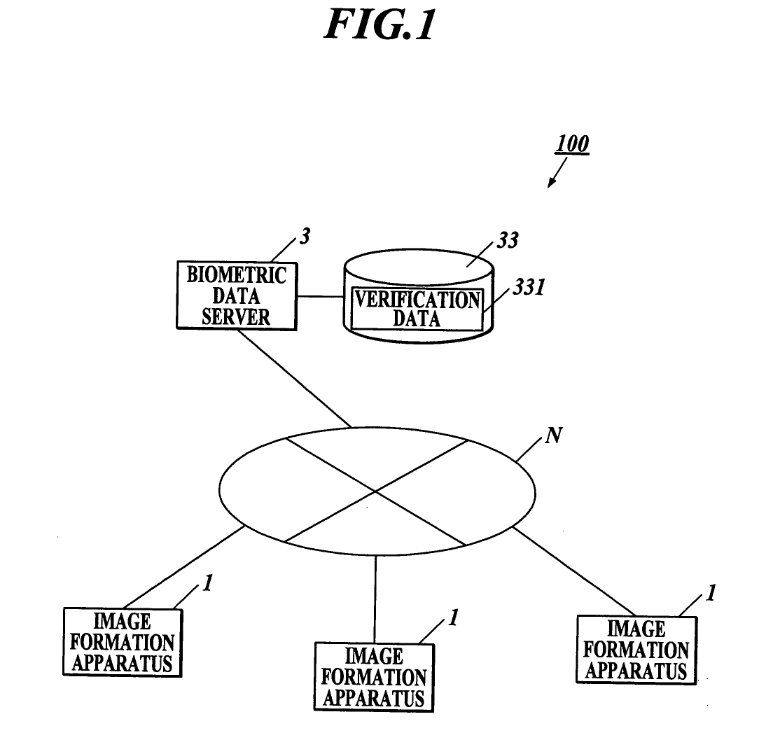

First, the configuration of a biometric authentication system 100 according to the embodiment is described with reference to FIGS. 1-3.

FIG. 1 is a view showing the schematic configuration of the biometric authentication system 100. As shown in FIG. 1, in the biometric authentication system 100 according to the embodiment, a plurality of image formation apparatuses 1 as biometric authentication apparatuses and a biometric data server 3 are connected to one another in the state capable of mutual communication through a network N such as a local area network (LAN), a wide area network (WAN) or the like. Incidentally, the kind and the number of the equipments connected to the network N are not limited to the example shown in FIG. 1.

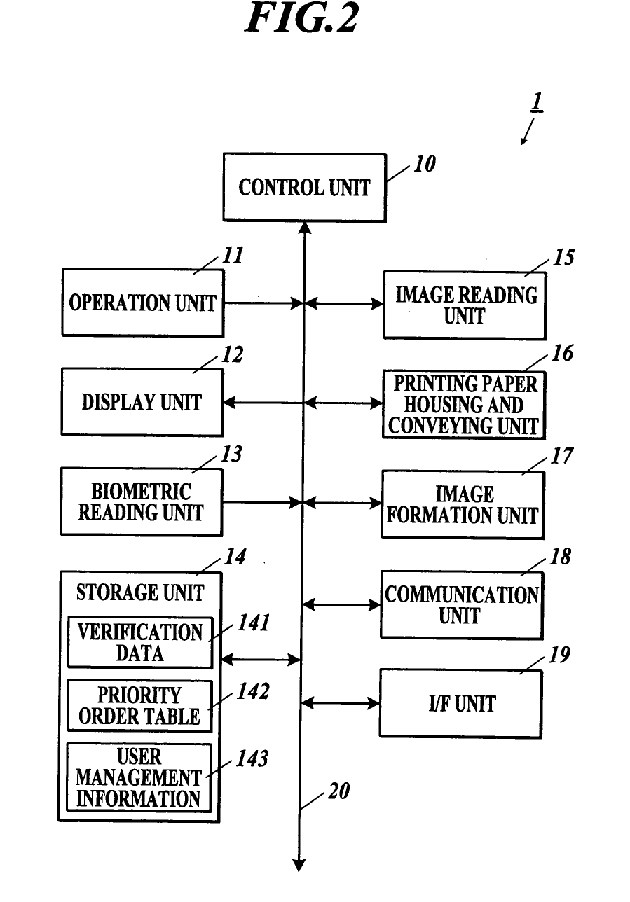

FIG. 2 is a view showing the internal configuration of each of the image formation apparatus 1. As shown in FIG. 1, the image formation apparatus 1 is composed of a control unit 10, an operation unit 11, a display unit 12, a biometric reading unit 13, a storage unit 14, an image reading unit 15, a printing paper housing and conveying unit 16, an image formation unit 17, a communication unit 18, an I/F unit 19 and the like. Each unit is connected with each other through a bus 20.

The control unit 10 is composed of a central processing unit (CPU) which is not shown, a random access memory (RAM) and the like. The CPU executes various kinds of processing by using a predetermined region of the RAM as a working area in cooperation with the various control programs previously stored in the storage unit 14, and wholly controls the operation of each unit constituting the image formation apparatus 1.

Specifically, the control unit 10 periodically or any time obtains (downloads) verification data 331 stored in a storage unit 33 of the biometric data server 3 together with the data ID corresponding to the verification data 331 through the network N, and stores the verification data 331 into the storage unit 14 as verification data 141 in association with the data ID. Incidentally, also a mode in which the difference between the verification data 331 and the existing verification data 141 stored in the storage unit 14 is detected at the time of performing the obtainment of the verification data 331 and only the difference value is obtained or is reflected on the verification data 141, may be adopted.

At the time of using the image formation apparatus 1, the control unit 10 performs one-to-N verification of one piece of biometric data read from the biometric reading unit 13 to a plurality (N) of pieces of verification data 141 previously stored in the storage unit 14 in the order based on the priority order registered in a priority order table 142, and the control unit 10 performs the control to allow the use of the image formation apparatus 1 only when the biometric data agrees with the verification data 141.

The control unit 10 stores the biometric data read with the biometric reading unit 13 based on an instruction signal input through the operation unit 11 into the storage unit 14 as verification data, and transmits the verification data to the biometric data server 3 through the network N.

When an instruction signal instructing deletion of specific verification data among a plurality of pieces of verification data stored in the storage unit 14 is input through the operation unit 11, the control unit 10 deletes the specified verification data from the storage unit 14, and transmits the instruction information instructing deletion of the specific verification data to the biometric data server 3 through the network N.

The control unit 10 makes the storage unit 14 store the image data read by the image reading unit 15. Further, the control unit 10 controls the printing paper housing and conveying unit 16 and the image formation unit 17 to make them print the image data read by the image reading unit 15, document data input through the communication unit 18, or the like on a sheet of printing paper.

The operation unit 11 is equipped with input keys and the like, and receives information input by an operation of a user as an input signal to output the input signal to the control unit 10. The display unit 12 is composed of a liquid crystal display (LCD) or the like, and displays various kinds of information based on display signals from the control unit 10. The display unit 10 may be integrally configured with the operation unit 11 to form a touch panel.

The biometric reading unit 13 is an apparatus capable of reading at least one kind of biometric data among various kinds of biometric data indicating physical features of a human being such as a fingerprint, a vein, an iris, a retina, a hand shape, a facial configuration, a somatotype, a voiceprint and the like, and is composed of various function units corresponding to biometric data which is an object to be read. The biometric reading unit 13 reads the biometric data of the user of the image formation apparatus 1 under the control by the control unit 10, and outputs the read biometric data to the control unit 10.

The storage unit 14 is equipped with a nonvolatile storage medium made of a magnetic recording medium, an optical recording medium or a semiconductor memory, and stores programs necessary for the operation of the image formation apparatus 1 and the data relative to the execution of the programs.

Specifically, the storage unit 14 previously stores (or manages) a plurality of pieces of verification data 141 for performing verification to the biometric data read by the biometric reading unit 13 in association with the data IDs. Here, the data IDs mean the identification information capable of uniquely identifying each user (verification data) such as the employee numbers of the users, and the verification data is managed based on the data IDs. Moreover, the storage unit 14 stores the priority order table 142 indicating the relations between the priority orders registered beforehand through the operation unit 11 and the verification data.

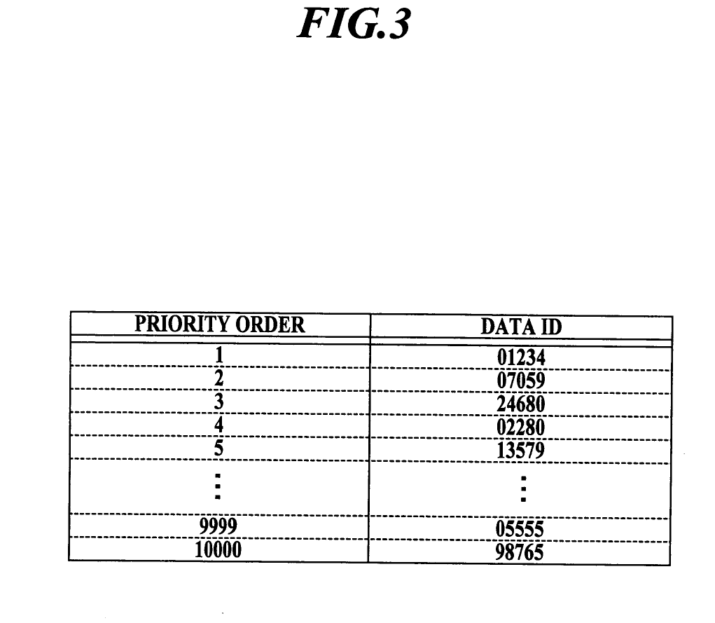

FIG. 3 is a view showing an example of the priority order table 142 stored in the storage unit 14. As shown in FIG. 3, priority orders (1, 2, 3, 4, 5 . . . 9999, 10000) and the data IDs of the respective pieces of verification data corresponding to the priority orders are set in association with each other. Incidentally, in the embodiment, it is meant that the first rank has the highest priority order, and the priority orders become gradually lower as the value of the rank increases.

The control unit 10 refers to the data IDs in order based on the priority orders of the data ID priority order table to read the verification data 141 corresponding to each data ID in order, and performs verification to the biometric data of the user read by the biometric reading unit 13.

Further, the storage unit 14 previously stores user management information 143 for identifying each user using the image formation apparatus 1. Here, the user management information indicates the information for managing the users of the image formation apparatus 1, and includes the identification information for identifying each user and/or the personal identification number peculiar to each user. Incidentally, in the embodiment, it is supposed that employee numbers of the users are used as the identification information and the employee numbers are regarded as the information corresponding to the data IDs described above.

When the control unit 10 is instructed by a user to register new verification data or to delete specific verification data, the control unit 10 urges the user to input user management information peculiar to the user. The control unit 10 performs registration of the new verification data or deletion of the specific verification data only when the user management information input by the user and the user management information 143 stored in the storage unit 14 agree with each other. That is, the user management information is an authentication key relative to the management of the verification data 141.

In FIG. 2, the image reading unit 15 includes a light source radiating light onto a manuscript, an image sensor such as a charge coupled device (CCD) image sensor, a complementary metal-oxide semiconductor (CMOS) image sensor or the like, which photoelectrically converts the light reflected from the manuscript, a scanning unit scanning the light to be radiated to the manuscript, an image processing unit performing various kinds of conversions and processing of an electric signal read by the image sensor to output image data, and the like, which are not shown. Under control by the control unit 10, the image reading unit 15 reads an image recorded in the manuscript, and generates image data to output the generated image data to the control unit 10.

The printing paper housing and conveying unit 16 includes a printing paper housing unit housing printing paper therein, a printing paper existence detection unit detecting whether printing paper is housed in the printing paper housing unit or not, a size detection unit detecting the paper size of the printing paper housed in the printing paper housing unit, a conveyance unit conveying the printing paper housed in the printing paper housing unit, and the like, all not shown. Under control by the control unit 10, the printing paper housing and conveying unit 16 conveys the printing paper with the paper size depending on image data or instructed through the operation unit 11 to the image formation position of the image formation unit 17, and ejects the printing paper after image formation.

The image formation unit 17 is a printer of an ink jet type, a laser type, a thermal transfer type, a dot impact type or the like, and forms and records an image on printing paper based on the image data input from the control unit 10.

The communication unit 18 is a modulator/demodulator (modem), a terminal adapter, a LAN adapter and the like, and performs communication control of various kinds of information given or received between the other equipment (biometric data server 3) connected to the network N under control by the control unit 10.

The I/F unit 19 is a communication interface which performs data communications with other apparatus, and is configured by, for example, universal serial bus (USB), IEEE 1284, IEEE 1394, PCMCIA or the like. Incidentally, the embodiment adopts a mode to store the verification data 141 and the priority order table 142 into the storage unit 14. However, when an external storage unit is connected to the I/F unit 19, a mode to store the verification data 141 and/or the priority order table 142 may be adopted.

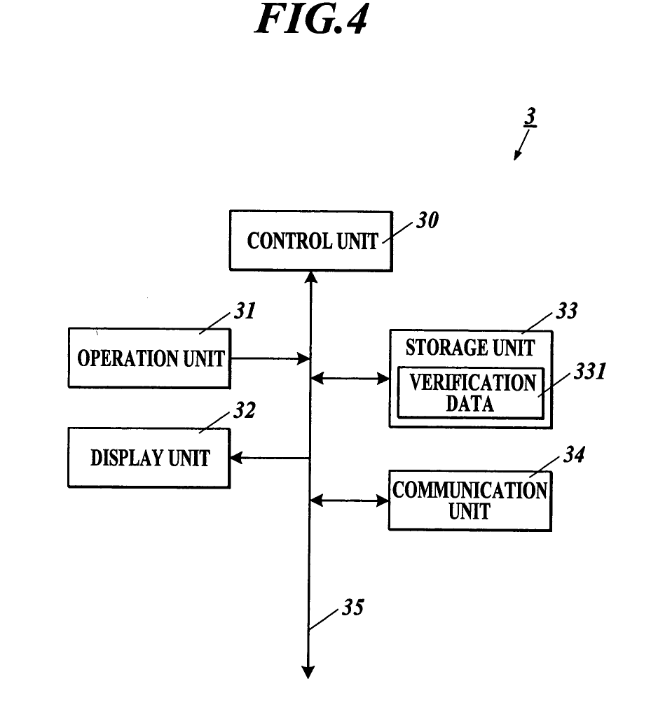

FIG. 4 is a view showing the internal configuration of the biometric data server 3. As shown in FIG. 4, the biometric data server 3 is composed of a control unit 30, an operation unit 31, a display unit 32, the storage unit 33, a communication unit 34 and the like, and each unit is connected with one another through a bus 35.

The control unit 30 is composed of a CPU which is not shown, an RAM and the like, and the CPU executes various kinds of processing using a predetermined region of the RAM as a working area in cooperation with various control programs stored in the storage unit 33 beforehand to wholly control the operation of each unit constituting the image formation apparatus 1.

Specifically, the control unit 30 controls the storage unit 33 so that an image formation apparatus 1 connected through the network N is able to obtain (download) the verification data 331 stored in the storage unit 33, and supplies the verification data 331 in response to an obtainment request from the image formation apparatus 1.

Moreover, when the control unit 30 receives verification data transmitted from the image formation apparatus 1, the control unit 30 stores (i.e., registers) the verification data into the storage unit 33. Moreover, when the control unit 30 receives instruction information instructing deletion of specific verification data transmitted from the image formation apparatus 1, the control unit 30 deletes the verification data specified based on the instruction information from the storage unit 33.

The operation unit 31 is equipped with the input keys and the like, and receives information input by an operation of the user as an input signal to output the input signal to the control unit 30. The display unit 32 is composed of a liquid crystal display (LCD) or the like, and displays various kinds of information based on a display signal from the control unit 30. Moreover, a mode in which the display unit 32 integrally constitutes a touch panel together with the operation unit 31 may be adopted.

The storage unit 33 is equipped with a nonvolatile storage medium composed of a magnetic recording medium, an optical recording medium or a semiconductor memory, and stores the programs necessary for the operation of the biometric data server 3 and the data relative to the execution of the programs.

Moreover, the storage unit 33 includes a data management region such as a data base in the storage region of the storage unit 33, and the storage unit 33 stores the verification data 331 to be used by each of the image formation apparatus 1 in association with the data IDs in the data management region to manage the verification data 331.

The communication unit 34 is a modem, a terminal adapter, a LAN adapter and the like, and performs communication control of various kinds of information given and received between the other equipment (image formation apparatus 1) connected to the network N under control by the control unit 30.

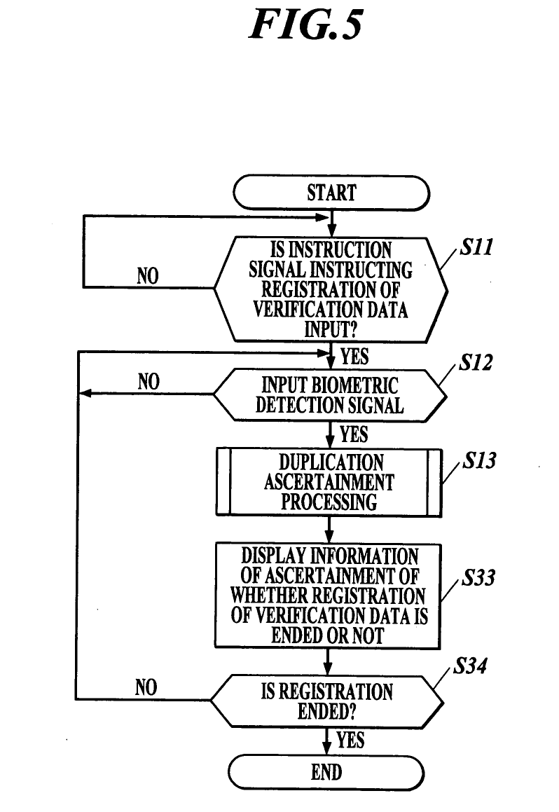

In the following, with reference to FIG. 5, the operation of the biometric authentication system 100 according to the embodiment is described.

FIG. 5 is a view showing the procedure of verification data registration processing of the image formation apparatus 1 according to the embodiment. Incidentally, each piece of processing in FIG. 5 shows the processing executed by the control unit 10 in cooperation with a predetermined program stored in the storage unit 14.

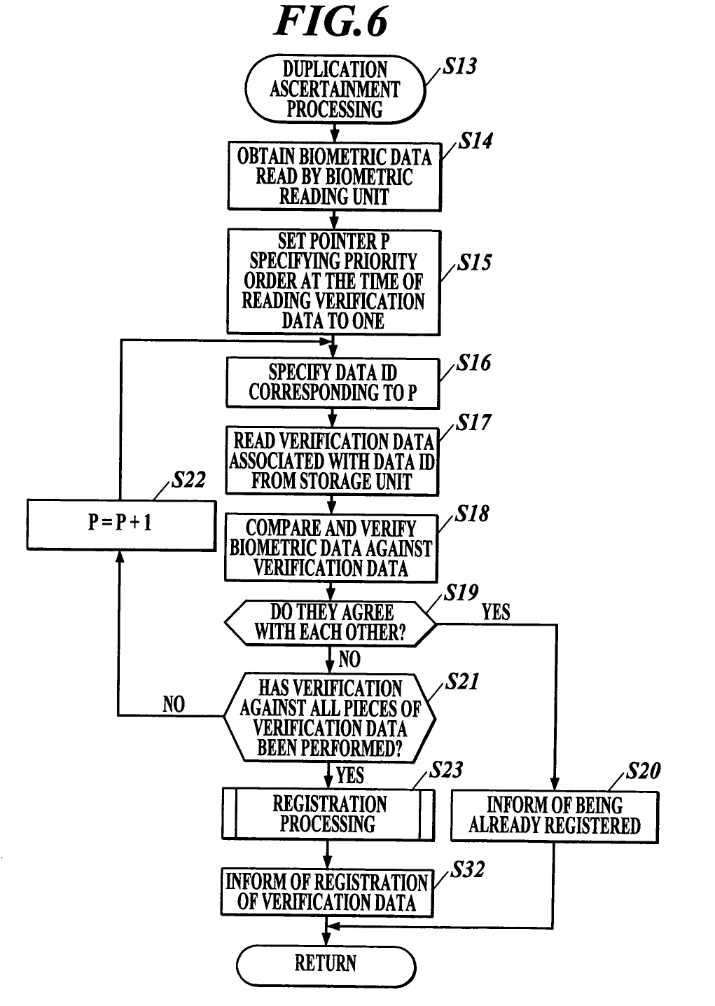

First, when an instruction signal instructing registration of verification data is input through the operation unit 11 (Step S11; Yes), the procedure stands by until a detection signal of a user is input from the biometric reading unit 13 (Step S12; No). When the input of the detection signal is ascertained (Step S12; Yes), the procedure moves to the duplication ascertainment processing (Step S13). In the following, the duplication ascertainment processing at Step S13 is described with reference to FIG. 6.

FIG. 6 is a view showing a procedure of the duplication ascertainment processing.

First, when the biometric data read by the biometric reading unit 13 is obtained (input) (Step S14), a pointer P specifying the priority order at the time of reading the verification data based on the data IDs of the priority order table 142 is set at the first rank (P=1) (Step S15).

Successively, a data ID corresponding to the present pointer P is specified from the priority order table 142 (Step S16), and the verification data 141 stored in association with the data ID is read from the storage unit 14 (Step S17). The read verification data 141 is verified against the biometric data obtained at Step S14 (Step S18), and it is judged whether both the data agree with each other or not (Step S19).

When it is judged that the verification data 141 and the biometric data agree with each other at Step S19 (Step S19; Yes), the information indicating agreement of the biometric data and the verification data 141 (for example, the character information such as “already registered” or the like) is displayed on the display 12, and thereby the fact is informed to the user (Step S20). Thereafter the procedure moves to Step S33 in FIG. 5.

On the other hand, when it is judged that the verification data 141 and the biometric data do not agree with each other at Step S19 (Step S19; No), it is judged whether all pieces of verification data 141 stored in the storage unit 14 have been verified against the biometric data or not (Step S21). Here, when it is judged that there is non-verified verification data 141 (Step S21; No), the priority order is lowered by one rank by the execution of the increment of the pointer P by one (P=P+1) (Step S22). Thereafter, the procedure returns to Step S16 again.

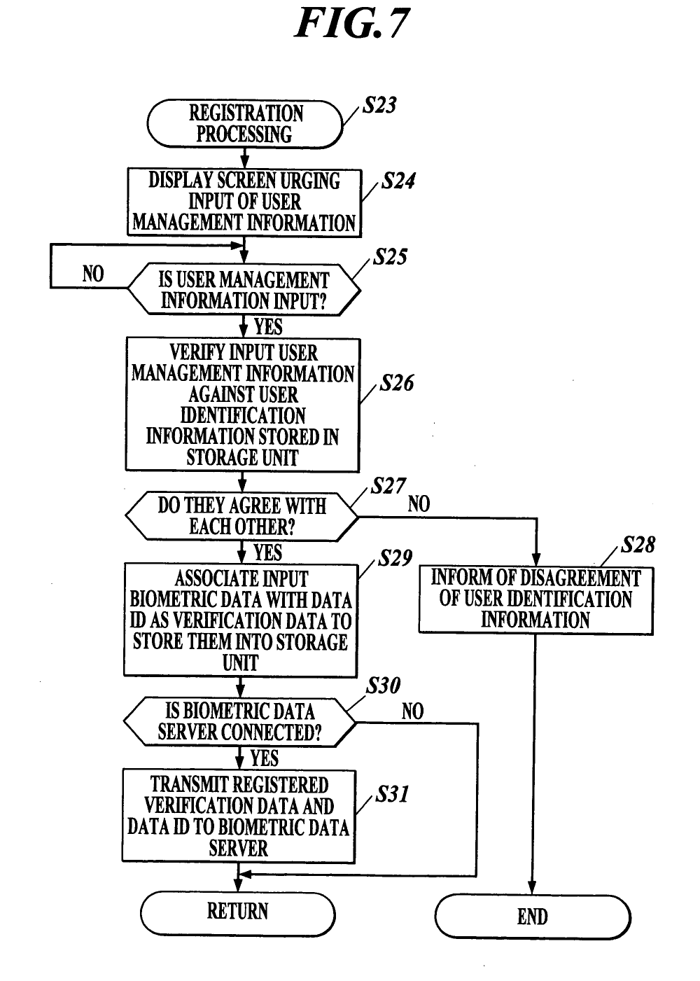

On the other hand, when it is judged that all pieces of verification data 141 have been verified against the biometric data (Step S21; Yes), the procedure moves to registration processing (Step S23). In the following, with reference to FIG. 7, the registration processing at Step S23 is described.

FIG. 7 is a view showing the procedure of a registration processing at Step S23.

First, a screen urging the user to input the user management information of the user of the present image formation apparatus 1 is displayed on the display unit 12 (Step S24), and the procedure stands by until the input of the user management information through the operation unit 11 (Step S25; No).

Here, when it is judged that the user management information has been input (Step S25; Yes), the user management information and the user management information 143 stored in the storage unit 14 beforehand are verified against each other (Step S26). When it is judged that the verification result indicates disagreement (Step S27; No), the information indicating disagreement of the user management information (for example, the character information such as “The user management information does not agree.” or the like) is displayed on the display unit 12 (Step S28). Thereafter, the present processing, i.e. the duplication ascertainment processing and the verification data registration processing, ends.

On the other hand, when it is judged that both the user management informations agree with each other (Step S27; Yes), the biometric data obtained at Step S14 is stored (registered) in the storage unit 14 in association with the data ID (employee number) included in the user management information input at Step S25 as the verification data (Step S29). Thereby, the data ID corresponding to the new verification data is registered in the priority order table 142, and a predetermined priority order is set to the data ID. Incidentally, the priority order to be set is not especially limited, and for example, the order of the first rank, which means the highest priority, or of the end rank may be set. When the priority order is specified through the operation unit 11 at the time of inputting the biometric data of the new registration object, the specified priority order may be set.

Subsequently, it is judged whether the biometric data server 3 is connected to the network N, to which the present image formation apparatus 1 is connected, or not. When it is judged that the biometric data server 3 is not connected to the network N (Step S30; No), the procedure moves to Step S32 in FIG. 6.

On the other hand, when it is judged that the biometric data server 3 is connected to the network N at Step S30 (Step S30; Yes), the verification data registered at Step S29 and the data ID corresponding to the verification data are transmitted (uploaded) to the biometric data server 3 through the network N (Step S31), and the procedure moves to Step S32 in FIG. 6.

In the biometric data server 3 which has received the verification data and the data ID transmitted from the image formation apparatus 1, the verification data and the data ID are stored in the storage unit 33 in association with each other by the control of the control unit 30, and consequently the registration of the new verification data is performed.

Returning to FIG. 6, at Step S32, the information indicating completion of the registration of the new verification data (for example, the character information such as “Registration of the verification data has been completed.” or the like) is displayed on the display unit 12 to be informed to the user (Step S32). Thereafter, the procedure moves to Step S33 in FIG. 5. According to such a configuration, because the storage (or registration) result is informed to the user, the user can recognize whether the verification data has been registered or not.

Returning to FIG. 5, at Step S33, the information of ascertaining whether the registration of the verification data is ended or not (for example, the character information such as “Is verification data registration processing ended?” or the like) is displayed on the display unit 12 (Step S33). When the instruction information instructing continuation of the registration of verification data is input through the operation unit 11 based on the display (Step S34; No), the procedure returns to Step S12 again. On the other hand, when the instruction information indicating ending of the registration of the verification data is input through the operation unit 11 at Step S34 (Step S34; Yes), the present processing is ended.

When the biometric data (verification data) which is read by the biometric reading unit 13 and becomes the new registration object is verified against the existing verification data in response to the instruction of the user in this manner and the verification result does not indicate the agreement of them, the verification data of the new registration object is stored (i.e., registered). Thereby, it becomes possible to register the verification data in response to the instruction of the user, and the duplication registration of the verification data with the existing verification data. Consequently, convenience of the management of the verification data can be improved.

Because the user is authenticated based on the user management information including the identification information for identifying the user and/or the personal identification number peculiar to the user and the storage (registration) of the verification data is performed only when the authentication has been normally performed, the security of the management of the verification data can be improved.

Further, because a new verification data 141 registered in the image formation apparatus 1 can be registered in the biometric data server 3 as a verification data 331, it is possible to reflect (or register) the registered new verification data 331 (141) from the biometric data server 3 to another image formation apparatus 1.

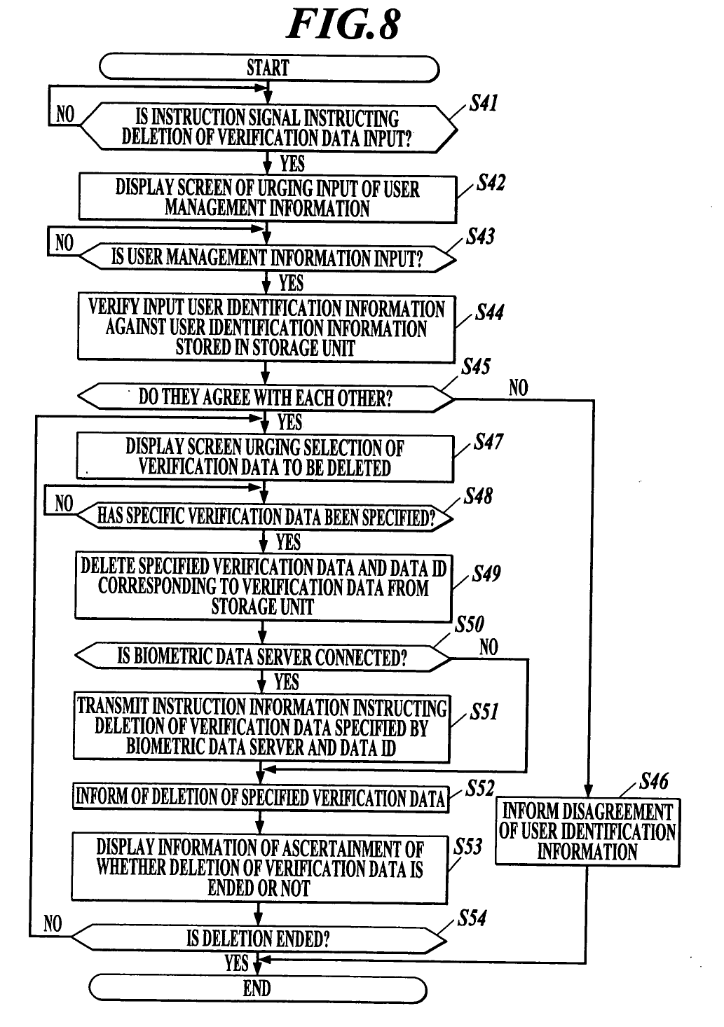

Next, verification data deletion processing is described with reference to FIG. 8.

FIG. 8 is a view showing the procedure of the verification data deletion processing in the image formation apparatus 1 according to the embodiment. Incidentally, each processing in FIG. 8 shows the processing executed by the control unit 10 in cooperation with a predetermined program stored in the storage unit 14.

First, when an instruction signal instructing deletion of verification data is input through the operation unit 11 (Step S41; Yes), a screen urging the user to input user management information for identifying the user of the present image formation apparatus 1 is displayed on the display unit 12 (Step S42), and the procedure stands by until the user management information is input through the operation unit 11 (Step S43; No).

Here, when it is judged that the user management information has been input (Step S43; Yes), the input user management information is verified against the user management information 143 stored in the storage unit 14 beforehand (Step S44). When it is judged that the verification result does not indicate the agreement of them (Step S45; No), the information indicating disagreement of the user management information (for example, the character information such as “The user management information does not agree.” or the like) is displayed on the display unit 12 to be informed to the user (Step S46). Thereafter, the present processing is ended.

On the other hand, when it is judged that both the user management informations agree with each other at Step S45 (Step S45; Yes), a screen urging the user to select the verification data to be the deletion object from the verification data stored in the storage unit 14 (Step S47), and the procedure stands by until specific verification data is specified through the operation unit 11 (Step S48; No).

Here, when it is judged that the specific verification data has been specified (Step S48; Yes), the specified specific verification data is deleted from the storage unit 14, and the information related to the data ID associated with the specific verification data is deleted from the priority order table 142 (Step S49).

Subsequently, it is judged whether the biometric data server 3 is connected to the network N or not. When it is judged that the biometric data server 3 is not connected to the network N (Step S50; No), the procedure moves to Step S52.

On the other hand, when it is judged that the biometric data server 3 is connected to the network N at Step S50 (Step S50; Yes), the instruction information indicating deletion of the verification data and the data ID corresponding to the verification data which have been deleted at Step S49 is transmitted to the biometric data server 3 through the network N (Step S51), and the procedure moves to Step S52.

When the biometric data server 3 receives the instruction information instructing deletion of the specific verification data and the data ID transmitted from the image formation apparatus 1, the biometric data server 3 deletes the instructed verification data and the data ID from the storage unit 33 by the control of the control unit 30.

At Step S52, the information indicating completion of deletion of the verification data specified by the user (for example, the character information of “The verification data has been deleted.” or the like) is displayed on the display unit 12 to be informed to the user (Step S52). Thereafter, the information ascertaining whether deletion of the verification data is ended or not (for example, the character information such as “Is the verification data deletion processing ended?” or the like) is displayed on the display unit 12 (Step S53).

Here, when the instruction information instructing continuation of deletion of the verification data is input through the operation unit 11 (Step S54; No), the procedure again returns to Step S47. On the other hand, when the instruction information instructing end of deletion of the verification data is input through the operation unit 11 at Step S54 (Step S54; Yes), the present processing is ended.

Because it becomes possible to delete verification data in response to an instruction from the user in this manner, the convenience regarding the management of verification data can be improved.

Further, because a user is authenticated based on the user management information including the identification information for identifying the user and/or the personal identification number peculiar to the user and deletion of the verification data is performed only when the authentication has been normally performed, the security regarding the management of the verification data can be improved.

Because the verification data 331 corresponding to the verification data which was deleted in the image formation apparatus 1 can be deleted from the biometric data server 3, it is possible to delete the deleted verification data 331 (141) from another image formation apparatus 1 through the biometric data server 3.

Incidentally, although the biometric data deletion processing according to the embodiment adopts the mode capable of specifying arbitrary verification data to be a deletion object from the verification data stored in the storage unit 14, the mode is not limited to this one. For example, a mode capable of deleting only the verification data corresponding to the data ID (employee information) of the user management information input from the user may be adopted. Moreover, although the mode of performing the input of the user management information is adopted in the biometric data deletion processing according to the embodiment, the mode is not limited to this one. For example, a mode capable of using the biometric data of a user read from the biometric reading unit 13 as a substitute of the user management information to delete only the verification data agreeing with the biometric data may be adopted.

### <Second Embodiment>

Next, a second embodiment of the present invention is described. For simplification of the description, the same components as those of the first embodiment are denoted by the same reference marks as those of the first embodiment, and the detailed descriptions of them are suitably omitted.

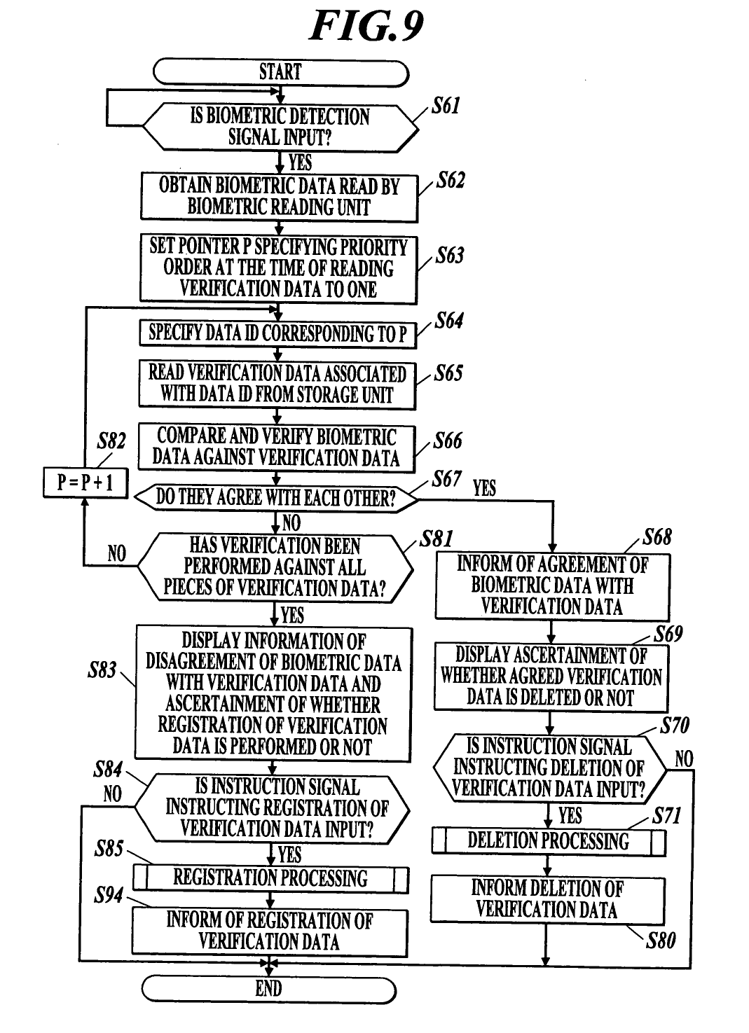

In the following, with reference to FIG. 9, the biometric authentication processing of the image formation apparatus 1 according to the embodiment is described.

FIG. 9 is a view showing the procedure of the biometric authentication processing of the image formation apparatus 1 according to the embodiment.

First, when the biometric authentication processing is started based on a biometric detection signal input from the biometric reading unit 13 (Step S61; Yes), the biometric data read by the biometric reading unit 13 is obtained (i.e., input) (Step S62).

Next, the pointer P specifying the priority order when verification data is read based on a data ID of the priority order table 142 is set to the first rank (P=1) (Step S63).

Successively, the data ID corresponding to the pointer P is specified based on the priority order table 142 (Step S64), and the verification data 141 stored in association with the data ID is read from the storage unit 14 (Step S65). When the read verification data 141 is verified against the biometric data obtained at Step S62 (Step S66), and it is judged whether both the data agree with each other or not (Step S67).

When it is judged that the verification data 141 and the biometric data agree with each other at Step S67 (Step S67; Yes), the information indicating agreement of the biometric data and the verification data 141 (for example, the character information such as “We succeeded in authentication.” or the like) is displayed on the display unit 12 to inform the user of the agreement (Step S68). Thereafter, the information ascertaining whether the agreed verification data is deleted or not (for example, the character information “Is the verification data deleted?” or the like) is displayed on the display unit 12 (Step S69).

Next, when the contents of the instruction information input by the user through the operation unit 11 is judged and it is judged that the instruction information instructing non-deletion of the verification data has been input (Step S70; No), the processing is immediately ended.

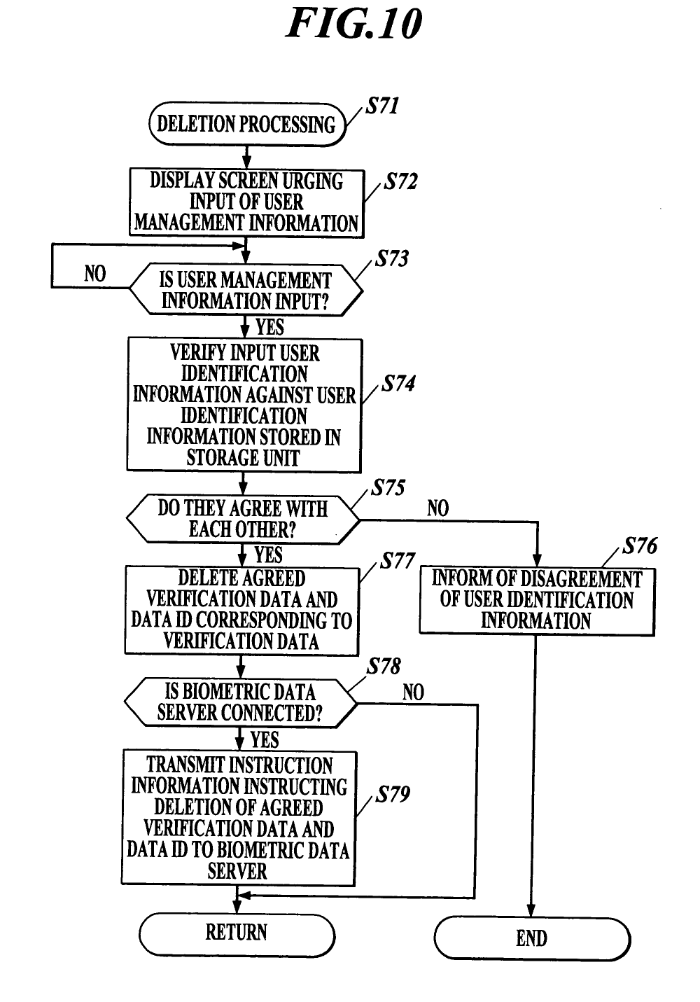

On the other hand, when it is judged that the instruction information instructing execution of deletion of the agreed verification data has been input at Step S70 (Step S70; Yes), the procedure moves to deletion processing (Step S71). In the following, the deletion processing at Step S71 is described with reference to FIG. 10.

FIG. 10 is a view showing the procedure of the deletion processing at Step S71.

First, a screen urging the user to input the user management information relative to the user of the present image formation apparatus 1 is displayed on the display unit 12 (Step S72), and the procedure stands by until the user management information is input through the operation unit 11 (Step S73; No).

Here, when it is judged that the user management information has been input (Step S73; Yes), the user management information is verified against the user management information 143 stored in the storage unit 14 beforehand (Step S74). When it is judged that the verification result does not indicate the agreement of them (Step S74; No), the information indicating disagreement of the user management information (for example, the character information such as “The user management information does not agree.” or the like) is displayed on the display unit 12 to inform the user of the disagreement (Step S76). Thereafter, the present processing and biometric authentication processing is ended.

On the other hand, when it is judged that both the user management information agree with each other at Step S75 (Step S75; Yes), the verification data which has agreed at Step S67 in FIG. 9 is deleted from the storage unit 14, and the information relative to the data ID associated to the verification data is deleted from the priority order table 142 (Step S77).

Next, it is judged whether the biometric data server 3 is connected to the network N or not. When it is judged that the biometric data server 3 is not connected to the network N (Step S78; No), the procedure moves to Step S80 in FIG. 9.

On the other hand, when it is judged that the biometric data server 3 is connected to the network N at Step S78 (Step S78; Yes), the instruction information instructing deletion of the verification data and the data ID corresponding to the verification data which have been deleted at Step S77 is transmitted to the biometric data server 3 through the network N (Step S79), and the procedure moves to Step S80 in FIG. 9.

When the biometric data server 3 receives the instruction information which has been transmitted from the image formation apparatus 1 and instructs deletion of the specific verification data and the data ID, the biometric data server 3 deletes the instructed verification data and the data ID from the storage unit 33 by the control of the control unit 30.

Returning to FIG. 9, the information indicating completion of the deletion of the verification data (for example, the character information such as “The verification data has been deleted.” or the like) is displayed on the display unit 12 to inform the user of the completion of the deletion (Step S80). Thereafter, the present processing is ended.

On the other hand, when it is judged that the verification data 141 and the biometric data do not agree with each other at Step S67 (Step S67; No), it is judged whether all pieces of verification data 141 stored in the storage unit 14 have been verified against the biometric data or not (Step S81). Here, when it is judged that there is non-verified verification data 141 (Step S81; No), the increment of the pointer P by one (P=P+1) is performed, and thereby the priority order is lowered by one rank (Step S82). Thereafter the procedure returns to Step S64 again.

On the other hand, when it is judged that all pieces of verification data 141 have been verified against the biometric data at Step S81 (Step S81; Yes), the information indicating disagreement of the biometric data with the verification data 141 (for example, the character information such as “The verification data has not been registered yet.” or the like) is displayed on the display unit 12, and the information indicating ascertainment of the registration of new verification data (for example, the character information such as “Is the verification data newly registered?” or the like) is displayed on the display unit 12 (Step S83).

Next, the contents of the instruction information input through the operation unit 11 by the user are judged. When it is judged that the instruction information instructing not to perform the registration of the new verification data has been input (Step S84; No), the present processing is immediately ended.

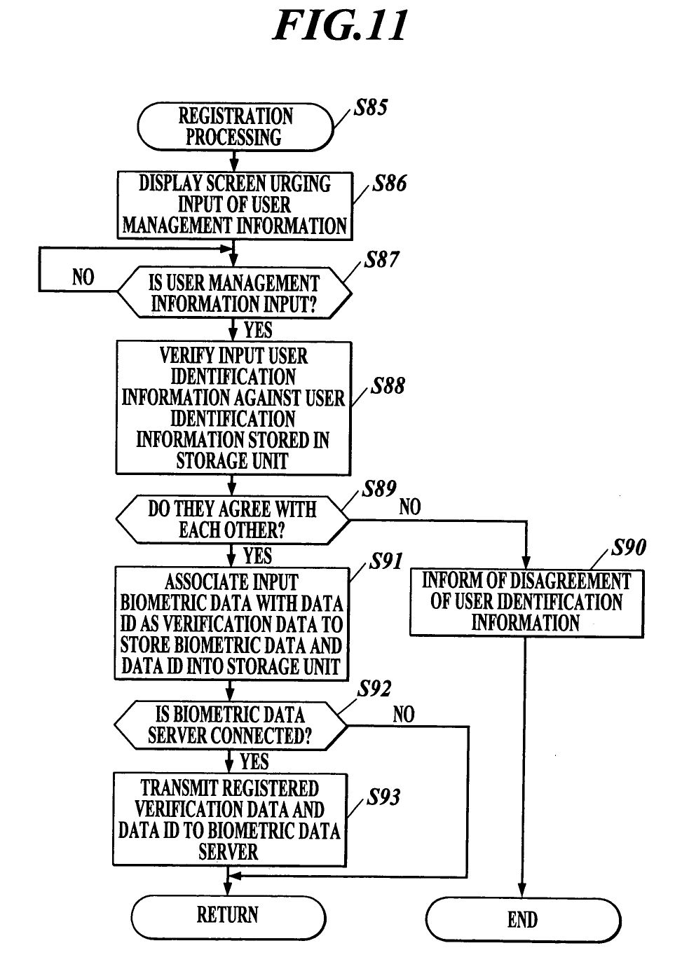

On the other hand, when it is judged that the instruction information instructing to perform the registration of the new verification data has been input at Step S84 (Step S84; Yes), the procedure moves to the registration processing at Step S85. In the following, the registration processing at Step S85 is described with reference to FIG. 11.

FIG. 11 is a view showing a procedure of the registration at Step S85.

First, a screen urging the user to input the user management information relative to the user of the present image formation apparatus 1 is displayed on the display unit 12 (Step S86), and the procedure stands by until the user management information is input through the operation unit 11 (Step S87; No).

Here, when it is judged that the user management information has been input (Step S87; Yes), the user management information is verified against the user management information 143 stored in the storage unit 14 beforehand (Step S88). When it is judged that the verification result does not indicate the agreement of them (Step S89; No), the information indicating disagreement of the user management information (for example, the character information such as “The user management information does not agree.” or the like) is displayed on the display unit 12 to inform the user of the disagreement (Step S90). Thereafter, the present processing and biometric authentication processing is ended.

On the other hand, when it is judged that both the user management information agree with each other at Step S89 (Step S89; Yes), the biometric data input at Step S62 is stored (registered) into the storage unit 14 as the verification data in association with the data ID (employee number) included in the user management information input at Step S87 (Step S91). Thereby, the data ID corresponding to the new verification data has been registered in the priority order table 142, and a predetermined priority order is set to the data ID. Incidentally, the priority order to be set is not especially limited, and for example, the order of the first rank, which means the highest priority, or of the end rank may be set. Moreover, when the priority order has been specified through the operation unit 11 at the time of inputting the biometric data of the new registration object, the specified priority order may be set.

Next, it is judged whether the biometric data server 3 is connected to the network N or not. When it is judged that the biometric data server 3 is not connected to the network N (Step S92; No), the procedure moves to Step S94 in FIG. 9.

On the other hand, when it is judged that the biometric data server 3 is connected to the network N at Step S92 (Step S92; Yes), the verification data newly stored at Step S91 and the data ID corresponding to the verification data are transmitted to the biometric data server 3 through the network N (Step S93), and the procedure moves to Step S94 in FIG. 9.

When the biometric data server 3 receives the verification data and the data ID transmitted from the image formation apparatus 1, the biometric data server 3 stores the verification data and the data ID into the storage unit 33 in association with each other by the control of the control unit 30 to perform the registration of the new verification data.

Returning to FIG. 9, the information indicating completion of the registration of the new verification data (for example, the character information such as “The registration of the verification data has been completed.” or the like) is displayed on the display unit 12 to inform the user of the completion of the registration (Step S94). Thereafter, the present processing is ended.

As described above, according to the biometric authentication system 100 according to the embodiment, the biometric data (verification data) read by the biometric reading unit 13 is verified against the existing verification data. When the verification result does not indicate the agreement of them, the storage (registration) is performed in accordance with the instruction of the user. Thereby, it becomes possible to register or delete the verification data in response to the instruction of the user, and because the duplication registration with the existing verification data can be prevented, the convenience of the management of the verification data can be improved.

Moreover, the authentication of the user is performed based on the user management information including the identification information for identifying the user and/or the personal identification number information peculiar to the user, and the storage (registration) or the deletion of the verification data is performed only when the authentication has been normally performed. Consequently, the security of the management of the verification data can be improved.

The detailed configurations and the detailed operations of the image formation apparatus 1 in the embodiments described above can be suitably modified within the range without departing the sprit of the present invention.

For example, when the registration or the deletion of verification data is performed, history information of the information indicating the contents of the processing (for example, the addition of the verification data of data ID: 07059, the deletion of the verification data of data ID: 24680, or the like) and the data ID of the user who has instructed the processing, both associated with each other, is recorded in order in the storage unit 14 or the storage unit 33. Thereby, because it becomes possible for an administrator to ascertain the record later, the convenience of the management of verification data can be improved.

Further, although the embodiments described above adopt a mode in which the execution of the procedure of each processing is realized by the cooperation of the control unit 10 and the predetermined programs stored in the storage unit 14, the execution mode is not limited to the one. The mode may be realized by exclusive hardware circuits.

What is claimed is:

1. A biometric authentication apparatus, comprising:
an operation unit receiving an instruction from a user;
a biometric reading unit reading biometric data;
a verification data storage unit storing a plurality of pieces of verification data for verifying against the biometric data;
a control unit verifying the biometric data read by the biometric reading unit against the verification data and storing the biometric data as the verification data into the verification data storage unit based on the instruction input through the operation unit; and
an information unit informing of a verification result by the control unit,
wherein the control unit verifies the biometric data against the verification data before the storage of the biometric data, and when the verification result indicates a disagreement, the control unit stores the biometric data into the verification data storage unit.

2. The biometric authentication apparatus of claim 1, wherein the information unit informs of a result of the storage of the biometric data by the control unit.

3. The biometric authentication apparatus of claim 1, further comprising a user management information storage unit storing user management information including identification information for identifying the user and/or personal identification number peculiar to the user,
wherein the control unit stores the biometric data into the verification data storage unit when the user management information input through the operation unit agrees with the user management information stored in the user management information storage unit.

4. The biometric authentication apparatus of claim 1, wherein, when an instruction instructing deletion of specific verification data among the plurality of pieces of verification data stored in the verification data storage unit is input, the control unit deletes the specified verification data from the verification data storage unit.

5. The biometric authentication apparatus of claim 4, further comprising a user management information storage unit storing user management information including identification information for identifying the user and/or personal identification number peculiar to the user,
wherein when the user management information input through the operation unit agrees with the user management information stored in the user management information storage unit, the control unit deletes the specified verification data from the verification data storage unit.

6. The biometric authentication apparatus of claim 1, wherein the biometric reading unit reads as the biometric data at least one of a fingerprint, a vein, an iris, a retina, a hand shape, a facial configuration, a somatotype and a voice print of the user.

7. A biometric authentication apparatus, comprising:
an operation unit receiving an instruction from a user;
a biometric reading unit reading biometric data;
a verification data storage unit storing a plurality of pieces of verification data for verifying against the biometric data;
a control unit verifying the biometric data read by the biometric reading unit against the verification data and storing the biometric data as the verification data into the verification data storage unit based on the instruction input through the operation unit; and
an information unit informing of a verification result by the control unit,
wherein the information unit gives a notice of urging ascertainment of whether to store the biometric data into the verification data storage unit when a verification result by the control unit indicates a disagreement, and
the control unit stores the biometric data into the verification data storage unit when an instruction allowing the storage of the biometric data into the verification data storage unit is input through the operation unit.

8. The biometric authentication apparatus of claim 7, wherein the information unit informs of a result of the storage of the biometric data by the control unit.

9. The biometric authentication apparatus of claim 7, further comprising a user management information storage unit storing user management information including identification information for identifying the user and/or personal identification number peculiar to the user,
wherein the control unit stores the biometric data into the verification data storage unit when the user management information input through the operation unit agrees with the user management information stored in the user management information storage unit.

10. The biometric authentication apparatus of claim 7, wherein when an instruction instructing deletion of specific verification data among the plurality of pieces of verification data stored in the verification data storage unit is input, the control unit deletes the specified verification data from the verification data storage unit.

11. The biometric authentication apparatus of claim 10, further comprising a user management information storage unit storing user management information including identification information for identifying the user and/or personal identification number peculiar to the user,
wherein when the user management information input through the operation unit agrees with the user management information stored in the user management information storage unit, the control unit deletes the specified verification data from the verification data storage unit.

12. The biometric authentication apparatus of claim 7, wherein the biometric reading unit reads as the biometric data at least one of a fingerprint, a vein, an iris, a retina, a hand shape, a facial configuration, a somatotype and a voice print of the user.

13. A biometric authentication system comprising: one or a plurality of the biometric authentication apparatus of claim 1, and a biometric data server equipped with a second verification data storage unit storing a plurality of verification data for verifying against biometric data read by the biometric authentication apparatus, the biometric authentication apparatus and the biometric data server connected with each other in a state capable of performing communication with each other,
wherein when the control unit of the biometric authentication apparatus stores the biometric data, the control unit transmits the biometric data to the biometric data server, and
the biometric data server is provided with a second control unit storing the biometric data transmitted from the biometric authentication apparatus into the second verification data storage unit as the verification data.

14. The biometric authentication system of claim 13, wherein when the control unit deletes specific verification data from the verification data storage unit, the control unit transmits instruction information instructing deletion of the specific verification data to the biometric data server, and
the second control unit deletes the specific verification data from the second verification data storage unit based on the instruction information transmitted from the biometric authentication apparatus.

15. A biometric authentication system comprising: one or a plurality of the biometric authentication apparatus of claim 7, and a biometric data server equipped with a second verification data storage unit storing a plurality of verification data for verifying against biometric data read by the biometric authentication apparatus, the biometric authentication apparatus and the biometric data server connected with each other in a state capable of performing communication with each other,
wherein when the control unit of the biometric authentication apparatus stores the biometric data, the control unit transmits the biometric data to the biometric data server, and
the biometric data server is provided with a second control unit storing the biometric data transmitted from the biometric authentication apparatus into the second verification data storage unit as the verification data.

16. The biometric authentication system of claim 15, wherein when the control unit deletes specific verification data from the verification data storage unit, the control unit transmits instruction information instructing deletion of the specific verification data to the biometric data server, and
the second control unit deletes the specific verification data from the second verification data storage unit based on the instruction information transmitted from the biometric authentication apparatus.

17. A biometric data management method, comprising:
an operation step to receive an instruction from a user;
a biometric reading step to read biometric data;
a verification data storage step to store a plurality of pieces of verification data for verifying against the biometric data;
a control step to verify the biometric data read in the biometric reading step against the verification data, and to store the biometric data as the verification data based on the instruction input in the operation step; and
an information step to inform of a verification result in the control step,
wherein the control step verifies the biometric data against the verification data before storing the biometric data, and when a verification result indicates a disagreement, the control step stores the biometric data.

18. The biometric data management method of claim 17, wherein the information step informs of a result of the storage of the biometric data in the control step.

19. The biometric data management method of claim 17, wherein further comprising a user management information storage step to store user management information including identification information for identifying the user and/or personal identification number peculiar to the user,
wherein the control step stores the biometric data into the verification data storage unit when the user management information input in the operation step agrees with the user management information stored in the user management information storage step.

20. The biometric data management method of claim 17, wherein when an instruction instructing deletion of specific verification data among the plurality of pieces of verification data stored in the verification data storage unit is input, the control step deletes the specified verification data.

21. The biometric data management method of claim 20, further comprising a user management information storage step to store user management information including identification information for identifying the user and/or personal identification number peculiar to the user,
wherein when the user management information input in the operation step agrees with the user management information stored in the user management information storage step, the control step deletes the specified verification data.

22. The biometric data management method of claim 17, wherein the biometric reading step reads as the biometric data at least one of a fingerprint, a vein, an iris, a retina, a hand shape, a facial configuration, a somatotye and a voice print of the user.

23. A biometric data management method, comprising:
an operation step to receive an instruction from a user;
a biometric reading step to read biometric data;
a verification data storage step to store a plurality of pieces of verification data for verifying against the biometric data;
a control step to verify the biometric data read in the biometric reading step against the verification data, and to store the biometric data as the verification data based on the instruction input in the operation step; and
an information step to inform of a verification result in the control step,
wherein the information step gives a notice of urging ascertainment of whether to store the biometric data when a verification result in the control step indicates a disagreement, and
the control step stores the biometric data when an instruction allowing the storage of the biometric data is input in the operation step.

24. The biometric data management method of claim 23, the information step informs of a result of the storage of the biometric data in the control step.

25. The biometric data management method of claim 23, wherein further comprising a user management information storage step to store user management information including identification information for identifying the user and/or personal identification number peculiar to the user,
wherein the control step stores the biometric data into the verification data storage unit when the user management information input in the operation step agrees with the user management information stored in the user management information storage step.

26. The biometric data management method of claim 23, wherein when an instruction instructing deletion of specific verification data among the plurality of pieces of verification data stored in the verification data storage unit is input, the control step deletes the specified verification data.

27. The biometric data management method of claim 26, further comprising a user management information storage step to store user management information including identification information for identifying the user and/or personal identification number peculiar to the user,
wherein when the user management information input in the operation step agrees with the user management information stored in the user management information storage step, the control step deletes the specified verification data.

28. The biometric data management method of claim 23, wherein the biometric reading step reads as the biometric data at least one of a fingerprint, a vein, an iris, a retina, a hand shape, a facial configuration, a somatotype and a voice print of the user.
